(19) United States
(12) Patent Application Publication
(10) Pub. No.: US 2021/0012247 A1
(43) Pub. Date: Jan. 14, 2021

(54) INFORMATION PROCESSING APPARATUS, INFORMATION PROCESSING METHOD, AND PROGRAM

(71) Applicant: NEC CORPORATION, Tokyo (JP)

(72) Inventor: Takashi SHIRAKI, Tokyo (JP)

(73) Assignee: NEC CORPORATION, Tokyo (JP)

(21) Appl. No.: 17/041,667

(22) PCT Filed: Mar. 25, 2019
(86) PCT No.: PCT/JP2019/012569

§ 371 Date: Sep. 25, 2020

(30) Foreign Application Priority Data
Mar. 28, 2018 (JP) 2018-062093

(51) Int. Cl. G06N 20/00; G06N 5/00

(52) U.S. Cl. CPC G06N 20/00; G06N 5/003

(57) ABSTRACT

An information processing apparatus of the present invention is configured to include a model generation means for, based on data including a plurality of attributes, generating a model using the attributes, and an attribute change means for changing the attributes used for generating the model, based on the generated model. The model generation means is configured to generate a new model, based on data including the changed attributes.

### TECHNICAL FIELD

The present invention relates to an information processing apparatus, an information processing method, and a program, for generating a model.

### BACKGROUND ART

In data analysis, a specific regularity is found from relevance between data units mixed in various types of data. For example, as a method of generating a model based on data including a plurality of attributes, heterogeneous learning has been known. Heterogeneous learning is a method of generating a prediction model of a decision tree structure. A leaf node of the lowest hierarchy of the decision tree includes a prediction formula represented by a regression formula, and an internal node that is a node other than the leaf node includes a branch condition for selecting a prediction formula. A node located at the uppermost hierarchy and configured of a branch condition is referred to as a root node. Here, each of a prediction formula and a branch condition includes an attribute. Therefore, by performing heterogeneous learning, it is possible to know an effect of each attribute on each model.

Here, an example of heterogeneous learning will be described. For example, as illustrated in FIG. 1, in data having attributes such as y, x₁, x₂, x₃, and the like, when the attributes x₁, x₂, x₃, and the like are used as explanatory variables and the attribute y is used as an objective variable, a model configured of a decision tree and prediction formulas in the leaf nodes thereof, as illustrated in FIG. 2, is obtained. In this case, a branch condition of each internal node is set by using an explanatory variable selected from candidates for explanatory variables configured of a large number of attributes, and for each leaf node divided by the branch, a prediction formula represented by a linear regression formula using the explanatory variable can be obtained. Since heterogeneous learning does not have reproducibility, a plurality of models can be generated through a plurality of repetitions called multi-start. Then, the generated models are evaluated, and an optimum model is selected. Examples of performing heterogeneous learning include prediction of electric power demand of a building, sales prediction of a store, and the like. In that case, attributes of data include electric power and sales that serve as objective variables, and weather, temperature, date, time, and the like that serve as explanatory variables.

Patent Literature 1: JP 2016-91343 A

### SUMMARY

However, in generation of models as described above, it is not always the case that a desired model can be obtained. For example, in heterogeneous learning, since the object thereof is to extract an optimum model, there is a case where only a few attributes that affect the model are extracted or the attributes are biased, depending on the generated model. In other words, regarding an attribute that is not included in the model or that is used only a little although it is included, it may be hidden by strong attributes. Therefore, it cannot be said that an effect of such an attribute on the model is represented appropriately. This result in a problem that the model only reflects a small number of sophisticated attributes and an effect of other attributes equivalent thereto cannot be examined appropriately.

Here, as an example of a method of generating a heterogeneous model, a method disclosed in Patent Literature 1 has been known. In Patent Literature 1, in order to improve the accuracy of a model, a model is generated through changes such as elimination and addition of attributes to be selected. However, in such a method, attributes to be used for generation of a model is simply changed arbitrarily and directly. Therefore, there are an enormous number of options, and it cannot be said that the selected attributes are sophisticated through heterogeneous learning. Accordingly, there is a problem that effects of attributes that are sophisticated through heterogeneous learning and effects of attributes not limited to a small number of them cannot be examined appropriately. Such a problem may arise not only in the case of heterogeneous learning but also in generation of models by means of any methods.

In view of the above, an object of the present invention is to provide an information processing apparatus, an information processing method, and a program, capable of solving the aforementioned problem, that is, a problem that effects of attributes on a generated model cannot be examined appropriately.

An information processing apparatus according to one aspect of the present invention is configured to include

a model generation means for, based on data including a plurality of attributes, generating a model using the attributes; and

an attribute change means for changing the attributes used for generating the model, based on the generated model.

The model generation means is configured to generate a new model, based on data including the changed attributes.

An information processing method according to one aspect of the present invention is configured to include

based on data including a plurality of attributes, generating a model using the attributes; changing the attributes used for generating the model, based on the generated model; and

further generating a new model, based on data including the changed attributes.

A program according to one aspect of the present invention is configured to cause an information processing apparatus to execute processing of:

based on data including a plurality of attributes, generating a model using the attributes;

changing the attributes used for generating the model, based on the generated model; and

further generating a new model, based on data including the changed attributes.

With the configurations described above, the present invention can appropriately examine the effects of all attributes on the model to be generated.

### BRIEF DESCRIPTION OF DRAWINGS

FIG. 1 illustrates an example of data used for generating a model.

FIG. 2 illustrates an example of a generated model.

FIG. 3 is a block diagram illustrating a configuration of an information processing apparatus according to a first exemplary embodiment of the present invention.

FIG. 4 is a flowchart illustrating an operation of the information processing apparatus disclosed in FIG. 3.

FIG. 5 is a drawing for explaining a state of determining an attribute to be eliminated in the present invention.

FIG. 6 is a drawing for explaining a state of determining an attribute to be eliminated in the present invention.

FIG. 7 is a drawing for explaining a state of determining an attribute to be eliminated in the present invention.

FIG. 8 is a drawing for explaining a state of determining an attribute to be eliminated in the present invention.

FIG. 9 is a drawing for explaining a state of determining an attribute to be eliminated in the present invention.

FIG. 10 is a block diagram illustrating a configuration of an information processing apparatus according to a second exemplary embodiment of the present invention.

### EXEMPLARY EMBODIMENTS

### First Exemplary Embodiment

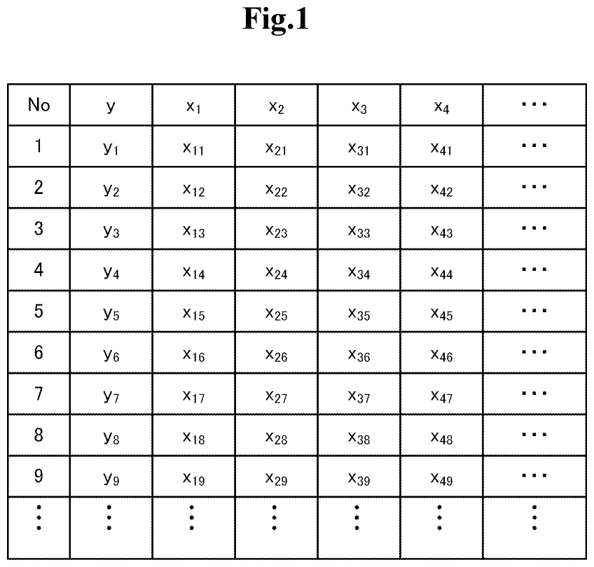

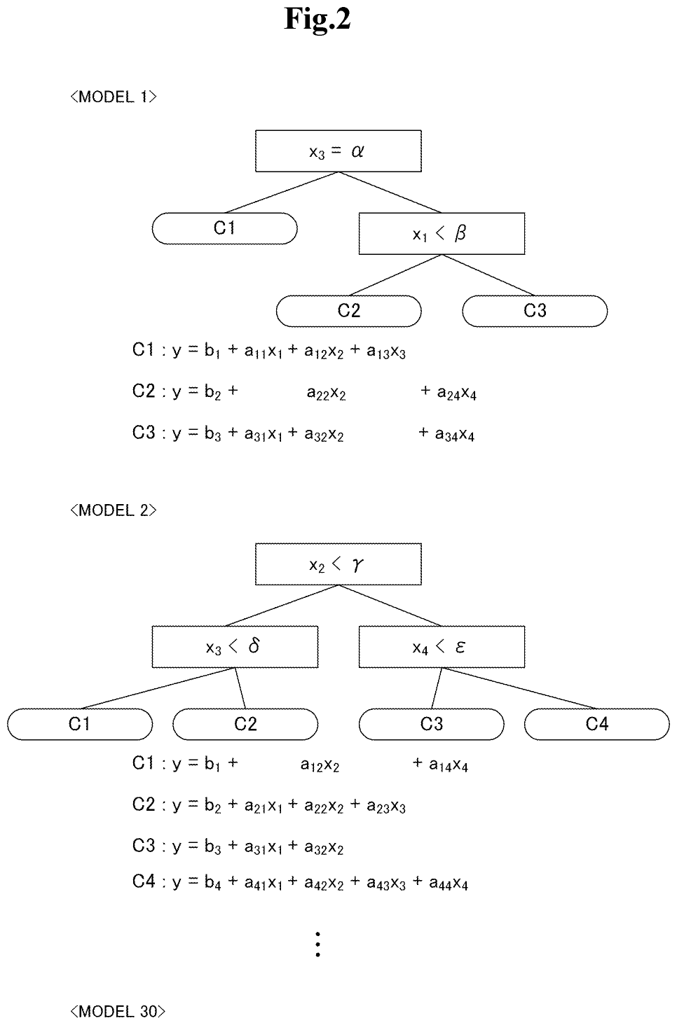

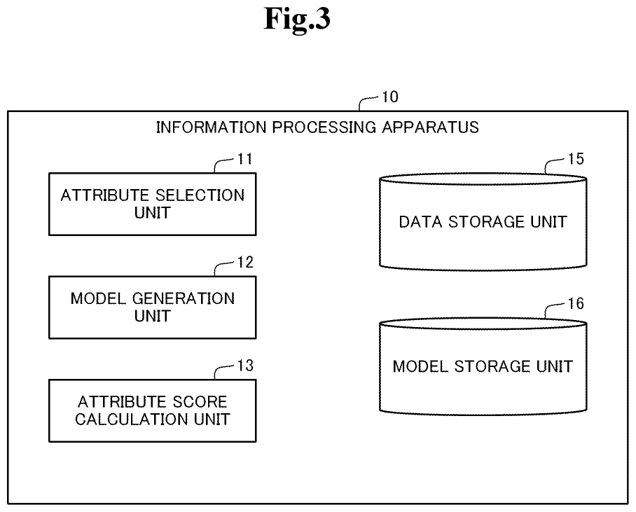

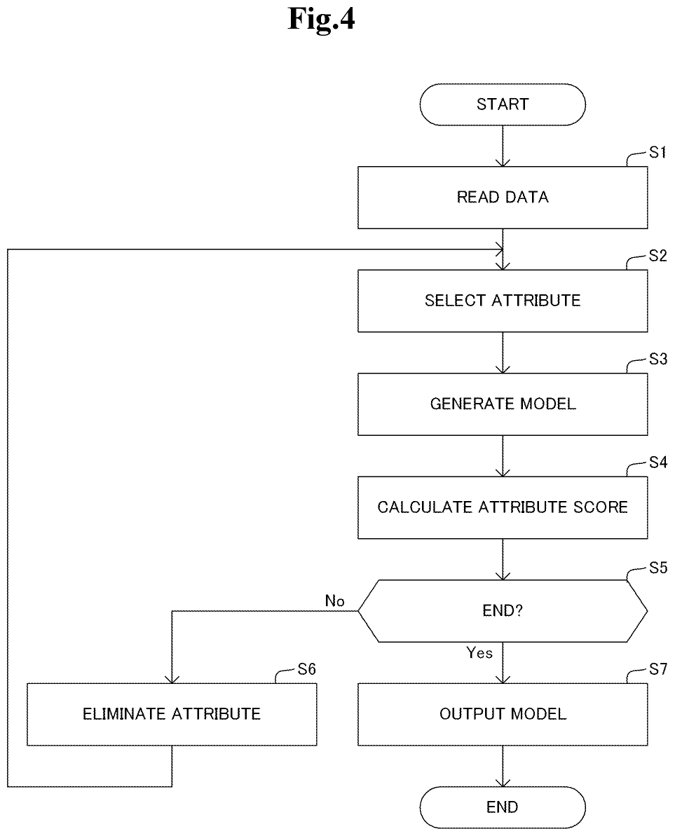

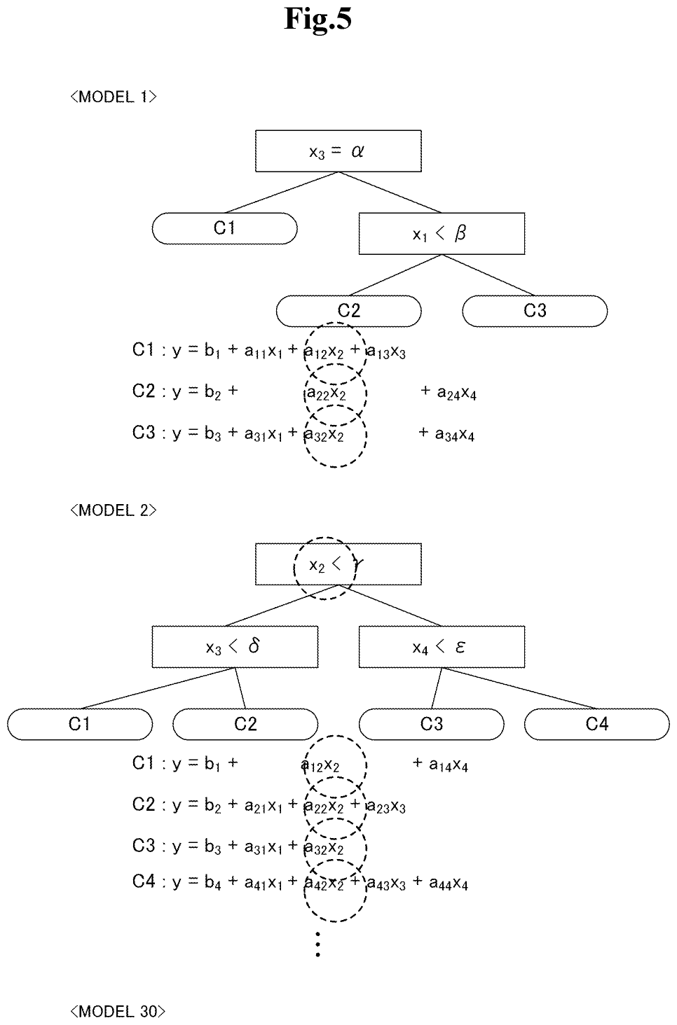

A first exemplary embodiment of the present invention will be described with reference to FIGS. 1 to 9. FIG. 1 illustrates an example of data to be analyzed, and FIG. 2 is an example of a generated model. FIG. 3 is a block diagram illustrating a configuration of an information processing apparatus, and FIG. 4 is a flowchart illustrating an operation of the information processing apparatus. FIGS. 5 to 9 are drawings for explaining a state of generating a model.

First, an information processing apparatus of the present invention is configured to generate a model from data that is an analysis target. For example, the present embodiment describes the case of performing heterogeneous learning by using data having attributes such as x₁, x₂, x₃, and the like as illustrated in FIG. 1 as an analysis target, and generating a plurality of models each formed of a decision tree as illustrated in FIG. 2. However, the present invention is applicable to a case of generating models by means of any methods, without being limited to heterogeneous learning.

An information processing apparatus 1 is configured of one or more information processing apparatuses each having an arithmetic unit and a storage device. As illustrated in FIG. 3, the information processing apparatus 1 includes an attribute selection unit 11, a model generation unit 12, and an attribute score calculation unit 13 that are constructed by execution of a program by the arithmetic unit. The information processing apparatus 1 also includes a data storage unit 15 and a model storage unit 16 that are formed in the storage device. Hereinafter, detailed configuration and operation of the information processing apparatus 1 will be described.

The data storage unit 15 stores therein data to be analyzed as illustrated in FIG. 1. The data to be analyzed is assumed to be data including attributes such as y, x₁, x₂, x₃, and the like and as an example, the attributes may include electric power of the building, weather, temperature, date, time, the number of attending workers, and the like. However, any data may be used. Note that “No.” represents the number of data, and the values of attributes of the same number are values observed at the same time.

The model storage unit 16 stores therein a model generated by learning data, as described below. The model to be stored is configured of a decision tree including a branch condition and a regression formula as illustrated in FIG. 2. However, the model may have any structure.

The attribute selection unit 11 first extracts and reads learning data to be used for creating a model, out of data stored in the data storage unit 15 (step S1 of FIG. 4). For example, the attribute selection unit 11 reads data units of data No. 1 to n, out of data illustrated in FIG. 1, as learning data. Note that the remaining data is used as test data for verifying the generated model, for example.

Then, the attribute selection unit 11 selects attributes to be used for generating a model, from the read learning data. In the present embodiment, all attributes of the data as illustrated in FIG. 1 are used for generating a model, and among them, an attribute y is selected as an objective variable, and the other attributes are used as candidates for explanatory variables, and attributes x₁ to xₙ are selected to be used as explanatory variables from the candidates. As an example, the objective variable y is electric power of the building, and the explanatory variables x₁ to xₙ are weather, temperature, date, time, the number of attending workers, and the like. Note that selection of attributes by the attribute selection unit 11 is automatically performed based on the criterion set in advance. However, it is not limited that the attribute selection unit 11 selects only partial attributes included in the data as an objective variable and explanatory variables. It is also possible to select all attributes as an objective variable and explanatory variables.

The model generation unit 12 performs heterogeneous learning by using values of the attributes selected as an objective variable and explanatory variables by the attribute selection unit 11, and generates a prediction model of a decision tree structure as illustrated in FIG. 2 (step 3 of FIG. 4). Here, in the present embodiment, in the decision tree structure as illustrated in FIG. 2, a node configured of a branch condition of the uppermost hierarchy is called a root node (for example, a branch condition of “x₃=α” shown by a dotted line circle in model 1 of FIG. 2), and a node represented by a regression formula of the lowest hierarchy is called a leaf node. Then, the leaf node of the decision tree includes a prediction formula C1 represented by a regression formula including an attribute, and an internal node that is a node other than the leaf node includes a branch condition including an attribute for selecting a prediction formula.

Here, the model generation unit 12 generates a plurality of models by a method so-called multi-start. For example, in the case of multi-start, by changing a learning method such as changing the explanatory variable used in a root node of a branch condition, it is possible to generate a plurality of models. In the present embodiment, it is assumed that different learning is performed in each of thirty times of multi-start, and thirty models are generated as illustrated in FIG. 2. However, the number of models to be generated is not limited to that described above.

Then, the attribute score calculation unit 13 calculates the score of each of the attributes used in the models, based on the models generated as described above (step S4 of FIG. 4). The score of an attribute is calculated to have a value that is considered to represent the effecting degree of the attribute on one or more generated models. A specific method of calculating a score of an attribute will be described later.

Then, from the score of the attribute calculated based on the models generated as described above, the attribute selection unit 11 changes the attributes to be used for generation of a model to be performed again. That is, the attribute score calculation unit 13 and the attribute selection unit 11 function as attribute change means for changing the attributes used for generation of a model. In particular, in the present embodiment, an attribute to be eliminated is determined from among the attributes used in the generation of the model performed immediately before, and such an attribute is eliminated. Thereby, the attributes to be used next time are changed (No at step S5 of FIG. 4, step S6).

Here, a method of calculating a score of each attribute used in a model and a method of determining an attribute to be eliminated will be described. As described above, in the present embodiment, the information processing apparatus 1 determines an attribute that may highly affect the generated model to be an attribute to be eliminated. Therefore, the used state of each attribute in the generated model is made into a score.

As an example, as the number of attributes used in the generated models is larger, a higher score is calculated. Specifically, in all of the generated models, the score of each attribute is calculated to be higher as the number thereof included in the branch condition and the regression formula is larger. Then, an attribute having the highest score is determined to be an attribute to be eliminated. In the example of FIG. 5, since the attribute x₂ appears most in the branch conditions and the regression formulas, the score of the attribute x₂ is calculated to be high, so that the attribute x₂ is determined to be an attribute to be eliminated. Note that in the above description, a score is calculated by adding the number of attributes appearing in the branch conditions and the regression formulas in all models. However, a score may be calculated by adding the number of attributes in some of the models, or a score may be calculated based on the number of attributes in one model. Moreover, a value based on the number of attributes appearing in one of the branch condition and the regression formula in a model may be used as a score, or a value based on the number of models in which an attribute appears may be used as a score of the attribute. Note that when the numbers of attributes appearing in a plurality of models are added to each other, addition may be performed by applying a weight to the number of attributes according to the content of the model such as an evaluation value of prediction accuracy of each model, and a score may be calculated based thereon. Moreover, the score of an attribute may be determined based on the number of attributes appearing in the models based on another criterion.

Here, an exemplary method of calculating an evaluation value of the model described above will be described. For example, by using a holdout method, it is possible to divide data illustrated in FIG. 1 into learning data and evaluation data, create a model using the learning data, obtain the accuracy of an average absolute error obtained when applying the model to the evaluation data, and use the value based on the accuracy as an evaluation value of the prediction accuracy. Note that the model evaluation method is not limited to a holdout method. Another method such as cross validation can be used. The accuracy index is not limited to an average absolute error, but may be another index such as an average absolute error rate or RSME. The method is not limited to that described above.

Then, based on the evaluation result of each model calculated as described above, weighting can be made among a plurality of models. For example, when thirty models are created in thirty times of multi-start, the models are aligned in descending order of the prediction accuracy in the evaluation method, and a weight is applied to each model such that a weight 30 is applied to the first model, a weight 29 is applied to the second model, and a weight 1 is applied to the thirtieth model. Thereby, even if the same attribute appears in each model, a difference may be made by the weight. Further, it is possible to apply a weight according to the value of the prediction accuracy. For example, after performing the sorting, it is possible to set a weight in such a manner that a model in which the number of errors is 100 is applied with a weight 1/100, a model in which the number of errors is 120 is applied with a weight 1/120, a model in which the number of errors is 538 is applied with a weight 1/538, and the like.

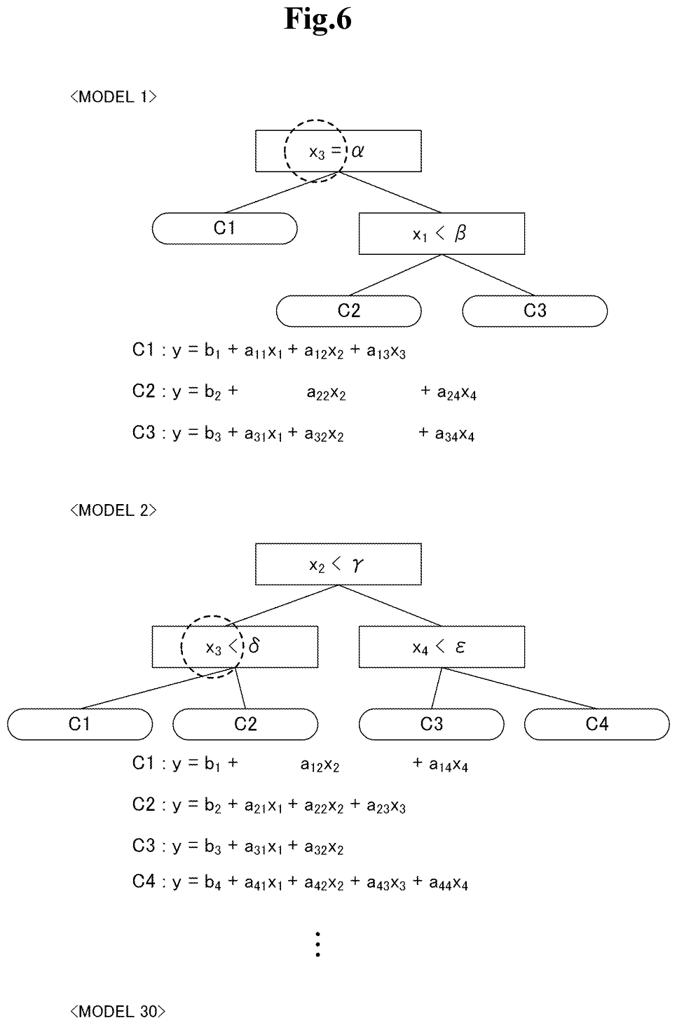

As another example, the information processing apparatus 1 calculates a higher score for an attribute whose distance from the root node of the decision tree is shorter, among the attributes used in the generated models. Here, “the distance from the root node” means the depth of the hierarchy from the root node of the uppermost hierarchy in the decision tree. Then, an attribute having the highest score is determined as an attribute to be eliminated. In the example of FIG. 6, the attribute x₃ is located at the branch condition of the root node of the model 1, and is located at the branch condition that is one hierarchy lower from the root node of the model 2. As described above, since the attribute x₃ is located at the root node in the model 1 and is located closest to the root node in the model 2, the score of the attribute x₃ is calculated to be high, and the attribute x₃ is determined as an attribute to be eliminated. However, the method of determining an attribute to be eliminated based on the distance from the root node is not limited to the method described above. For example, only an attribute located at the branch condition of the root node may be determined to be eliminated, or an attribute to be eliminated may be determined according to another criterion.

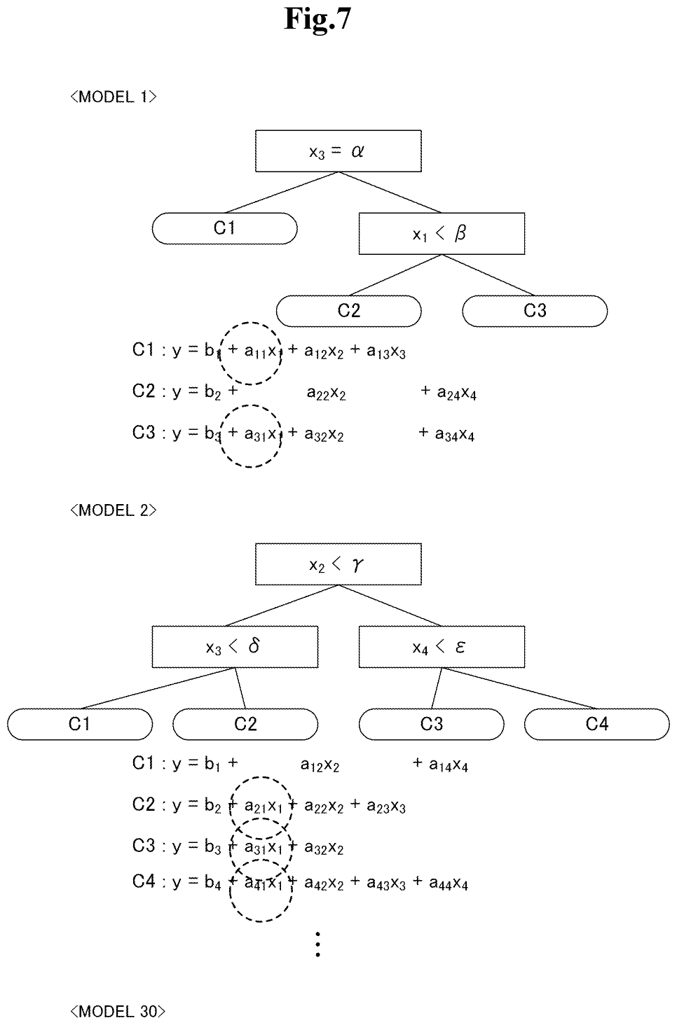

As another example, when the coefficient of an attribute in the regression formulas of the generated models is larger, the information processing apparatus 1 calculates the score of such an attribute larger. Then, an attribute having the highest score is determined as an attribute to be eliminated. For example, in the example of FIG. 7, the total value of the coefficients of the attribute x₁ in the regression formulas of the respective models is calculated as a score of the attribute x₁. At that time, the magnitude of the coefficient of the attribute in the regression formula may be determined according to the numerical value including positive and negative, or may be determined according to the absolute value by eliminating positive and negative. Moreover, the score based on the coefficient of the attribute in the regression formula may be a total value of the coefficients of each attribute as described above, or may be calculated based on the coefficient by means of another method such as using a maximum value as a score.

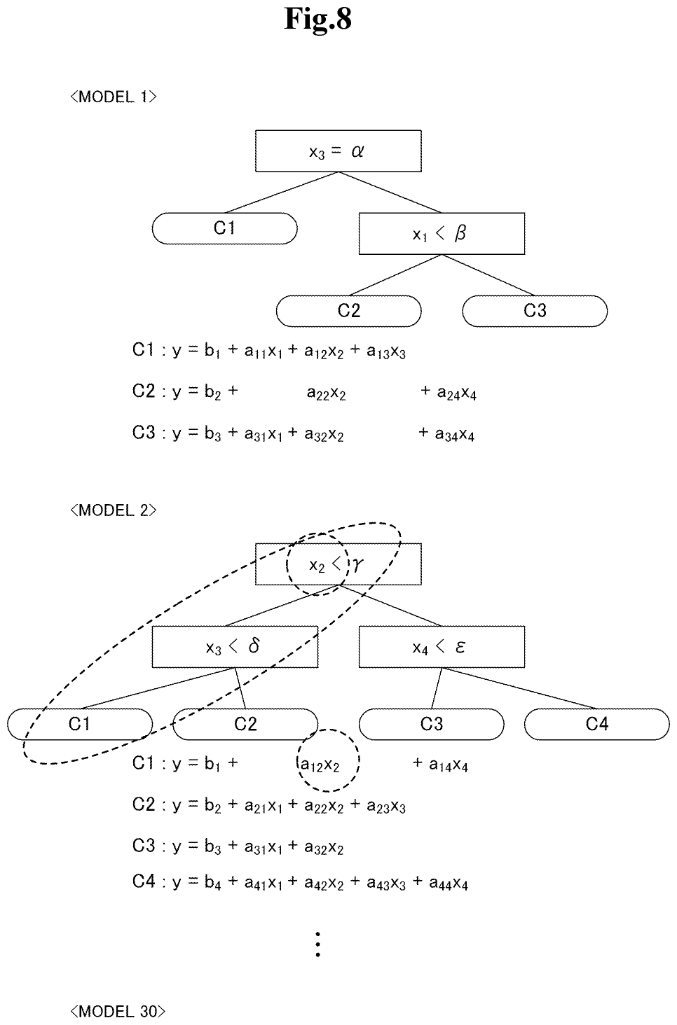

As another example, when generating a model formed of a decision tree, as the number of data units used for generating a branch condition and a regression formula is larger, the information processing apparatus 1 calculates the score of an attribute included in the branch condition and the regression formula higher. Then, an attribute having the highest score is determined as an attribute to be eliminated. For example, in the example of FIG. 8, when generating a decision tree, if a large number of data units are used for generating a route including the condition branch and the regression formula surrounded by an ellipse of a dotted line in the decision tree of the model 2, that is, if a large number of data units pass through the route, the score of the attribute included in such a route is calculated to be high. In that case, for example, if the score of the attribute x₂ included in the route surrounded by the ellipse having a large number of data units is calculated to be high, the attribute x₂ is determined to be eliminated.

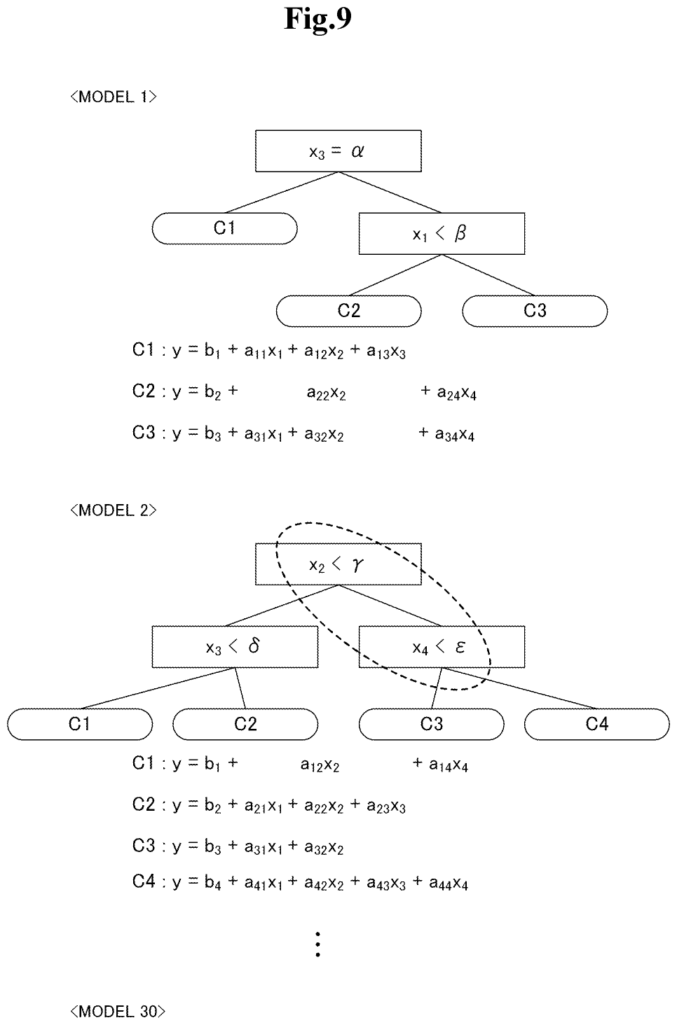

As another example, the information processing apparatus 1 examines relevance among a plurality of attributes used in the generated model, and calculates the score of each attribute from the relevance. Then, an attribute having the highest score is determined as an attribute to be eliminated. For example, in the example of FIG. 9, in the decision tree of the model 2, the attributes x₂ and x₄ included in the condition branches located at continuous hierarchies are determined to be attributes having high relevance, so that the scores of these attributes are calculated to be high. Then, both or one of the attributes x₂ and x₄ is determined as an attribute to be eliminated. Note that when one of them is determined as an attribute to be eliminated, another criterion such as selecting an attribute closer to the root node may be used.

As another example, among the attributes used in the generated model, the information processing apparatus 1 calculates the score of an attribute, previously set that the property thereof is uncontrollable, to be high, and determines such an attribute to be eliminated. For example, in the above example, when the objective variable is electric power of a building, “the number of attending workers” among the explanatory variables is controllable but “weather” is uncontrollable. The score of such an uncontrollable attribute is calculated to be high.

Note that in the above description, the case of eliminating an attribute having the highest score is shown as an example. However, it is not necessarily limited to eliminating an attribute of the highest score. An attribute to be eliminated may be determined under any condition based on the score, or one or a plurality of attributes may be determined to be attributes to be eliminated. Moreover, the information processing apparatus 1 may use one method among the methods of calculating the scores of attributes as described above, or may combine some of them. Furthermore, the score calculation method may be any method without being limited to that described above.

Then, the attribute selection unit 11 excludes the attribute determined to be eliminated as described above from candidates for explanatory variables used for generating a model, uses the remaining attributes as candidates for explanatory variables and, from among them, selects an attribute to be used for generating a model (step S2 of FIG. 4). That is, an attribute is selected at step S2 of FIG. 4, from the remaining attributes after the elimination of the attribute determined to be eliminated at step S6 of FIG. 4.

Then, the model generation unit 12 performs heterogeneous learning as described above by using values of the attributes selected by the attribute selection unit 11, and generates a prediction model of a decision tree structure (step 3 of FIG. 4). In this step, the model generation unit 12 also generates a plurality of models by a method so-called multi-start.

Thereafter, scores of the attributes may be calculated based on the generated models and an attribute may be eliminated, and a model may be generated again by using the remaining attributes. Meanwhile, when generation of a model ends according to any criterion (Yes at step S5 of FIG. 4), the model generation unit 12 stores the generated model in the model storage unit 16, and outputs it to the user (step S7 of FIG. 4).

As described above, in the present invention, first, a model is generated using a plurality of attributes, and based on the generated model, it is determined to eliminate an attribute that affects the model. Then, after eliminating the attribute determined to be eliminated, a model is generated again using the remaining attributes. Elimination of an attribute and generation of a model are repeated as required. Thereby, in a model that is generated again, an effect of the eliminated attribute can be removed. Consequently, it is also possible to generate a model taking into account of an effect of an attribute different from the eliminated attribute. Therefore, effects of various attributes on the data can be examined appropriately.

While the case of eliminating an attribute used in generation of a model has been shown as an example, in the present invention, another model may be generated again based on the generated model by using attributes in which an attribute not used in the generated model is added. In that case, an effect of the added attribute can be examined. Further, in the present invention, based on the generated model, it is possible to eliminate an attribute used in generation of the model, and also generate a model again by using the changed attributes in which a new attribute is added. Note that the attributes to be used for generating a mode can be changed in any methods.

### Second Exemplary Embodiment

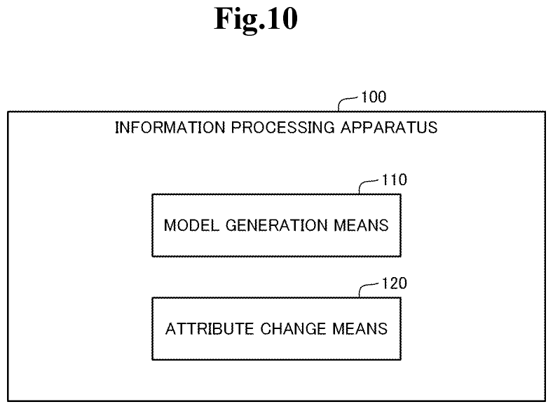

Next, a second exemplary embodiment of the present invention will be described with reference to FIG. 10. FIG. 10 is a block diagram illustrating a configuration of an information processing apparatus according to the second exemplary embodiment. Note that the present embodiment shows the outline of the configuration of the information processing apparatus described in the first exemplary embodiments.

As illustrated in FIG. 10, an information processing apparatus 100 of the present embodiment is configured to include

a model generation means 110 for, based on data including a plurality of attributes, generating a model using the attributes, and

an attribute change means 120 for changing the attributes used for generating the model, based on the generated model.

The model generation means 110 is configured to generate a new model, based on data including the changed attributes.

Note that the model generation means 110 and the attribute change means 120 are implemented by execution of a program by the information processing apparatus.

Then, the information processing apparatus 100 having the above-described configuration operates to execute processing of

based on data including a plurality of attributes, generating a model using the attributes,

changing the attributes used for generating the model, based on the generated model, and

further generating a new model, based on data including the changed attributes.

According to the invention described above, first, a model is generated using a plurality of attributes, and the attributes are changed based on the generated model, and then a model is generated again with use of the changed attributes. Therefore, it is also possible to generate a model taking into account of an effect of the changed attributes. Therefore, effects of various attributes on the data can be examined appropriately.

### <Supplementary Notes>

The whole or part of the exemplary embodiments disclosed above can be described as, but not limited to, the following supplementary notes. Hereinafter, outlines of the configurations of an information processing apparatus, an information processing method, and a program, according to the present invention, will be described. However, the present invention is not limited to the configurations described below.

### (Supplementary Note 1)

An information processing apparatus comprising:

model generation means for, based on data including a plurality of attributes, generating a model using the attributes; and

attribute change means for changing the attributes used for generating the model, based on the generated model, wherein

the model generation means generates a new model, based on data including the changed attributes.

### (Supplementary Note 2)

The information processing apparatus according to supplementary note 1, wherein

the attribute change means eliminates at least one attribute of the attributes used in the model, based on the generated model, and

the model generation means generates a new model, based on data including another attribute that is different from the eliminated attribute.

### (Supplementary Note 3)

The information processing apparatus according to supplementary note 1 or 2, wherein

the attribute change means determines an attribute to be eliminated based on used states of the attributes in the generated model, and eliminates the attribute.

### (Supplementary Note 4)

The information processing apparatus according to supplementary note 3, wherein

the attribute change means calculates an effecting degree of each of the attributes according to a criterion preset to the model based on the used states of the attributes in the generated model, and eliminates the attribute having a high effecting degree.

### (Supplementary Note 5)

The information processing apparatus according to supplementary note 3 or 4, wherein

the model generation means performs generation of the model a plurality of times based on data including same attributes, and

the attribute change means determines the attribute to be eliminated based on a number of the attributes used in a plurality of generated models.

### (Supplementary Note 6)

The information processing apparatus according to any of supplementary notes 3 to 5, wherein

the model generation means generates the model including a decision tree, and

the attribute change means determines the attribute to be eliminated based on a distance from a root node in the decision tree of the attributes used in the generated model.

### (Supplementary Note 7)

The information processing apparatus according to any of supplementary notes 3 to 6, wherein

the model generation means generates the model including a decision tree in which a leaf node is a regression formula including the attribute, and

the attribute change means determines the attribute to be eliminated based on a coefficient of the attribute in the regression formula in the generated model.

### (Supplementary Note 8)

The information processing apparatus according to any of supplementary notes 3 to 6, wherein

the model generation means generates the model including a decision tree in which a leaf node is a regression formula including the attribute and a node other than the leaf node is a branch condition including the attribute, and

the attribute change means determines the attribute to be eliminated based on a number of units of the data used in generation of the branch condition and/or the regression formula in the decision tree of the generated model.

### (Supplementary Note 9)

The information processing apparatus according to any of supplementary notes 3 to 8, wherein

the attribute change means eliminates at least one attribute of the plurality of the attributes, based on relevance among the plurality of the attributes used in the generated model.

### (Supplementary Note 10)

The information processing apparatus according to any of supplementary notes 2 to 9, wherein

the attribute change means eliminates the at least one attribute that is uncontrollable according to a preset criterion.

### (Supplementary Note 10.1)

The information processing apparatus according to any of supplementary notes 1 to 10, wherein

the model generation means generates a plurality of models using the attributes, and

the attribute change means determines an attribute to be eliminated based on used states of the attributes in the plurality of the generated models, and eliminates the attribute.

### (Supplementary Note 10.2)

The information processing apparatus according to supplementary note 10.1, wherein

the attribute change means evaluates each of the plurality of the generated models by a preset method, sets, to each of the models, a weight according to an evaluation result of each of the models, determines the attribute to be eliminated based on the used state of each attribute in each of the models and the weight set to each of the models, and eliminates the attribute.

### (Supplementary Note 11)

An information processing method comprising:

based on data including a plurality of attributes, generating a model using the attributes;

changing the attributes used for generating the model, based on the generated model; and

further generating a new model, based on data including the changed attributes.

### (Supplementary Note 11.1)

The information processing method according to supplementary note 11, further comprising;

based on the generated model, eliminating at least one attribute of the attributes used in the model; and

generating a new model, based on data including another attribute that is different from the eliminated attribute.

### (Supplementary Note 11.2)

The information processing method according to supplementary note 11 or 11.1, further comprising

determining an attribute to be eliminated based on used states of the attributes in the generated model, and eliminating the attribute.

### (Supplementary Note 11.3)

The information processing method according to supplementary note 11.2, further comprising

calculating an effecting degree of each of the attributes according to a criterion preset to the model based on the used states of the attributes in the generated model, and eliminating the attribute having a high effecting degree.

### (Supplementary Note 11.4)

The information processing method according to supplementary note 11.2 or 11.3, wherein

the generating the model includes performing generation of the model a plurality of times, based on data including same attributes, and

the method further comprises determining the attribute to be eliminated based on a number of the attributes used in a plurality of generated models.

### (Supplementary Note 11.5)

The information processing method according to any of supplementary notes 11.2 to 11.4, wherein

the generating the model includes generating the model including a decision tree, and

the method further comprises determining the attribute to be eliminated based on a distance from a root node in the decision tree of the attributes used in the generated model.

### (Supplementary Note 11.6)

The information processing method according to any of supplementary notes 11.2 to 11.5, wherein

the generating the model includes generating the model including a decision tree in which a leaf node is a regression formula including the attribute, and

the method further comprises determining the attribute to be eliminated based on a coefficient of the attribute in the regression formula in the generated model.

### (Supplementary Note 11.7)

The information processing apparatus according to any of supplementary notes 11.2 to 11.6, wherein

the generating the model includes generating the model including a decision tree in which a leaf node is a regression formula including the attribute and a node other than the leaf node is a branch condition including the attribute, and

the method further comprises determining the attribute to be eliminated based on a number of units of the data used in generation of the branch condition and/or the regression formula in the decision tree of the generated model.

### (Supplementary Note 11.8)

The information processing method according to any of supplementary notes 11.2 to 11.7, further comprising

eliminating at least one attribute of the plurality of the attributes, based on relevance among the plurality of the attributes used in the generated model.

### (Supplementary Note 11.9)

The information processing method according to any of supplementary notes 11.1 to 11.8, further comprising

eliminating the at least one attribute that is uncontrollable according to a preset criterion.

### (Supplementary Note 12)

A program for causing an information processing apparatus to execute processing of:

based on data including a plurality of attributes, generating a model using the attributes;

changing the attributes used for generating the model, based on the generated model; and

further generating a new model, based on data including the changed attributes.

Note that the program described above is stored using a non-transitory computer readable medium of any type, and can be supplied to a computer. A non-transitory computer readable medium includes a tangible storage medium of any type. Examples of a non-transitory computer readable medium include a magnetic recording medium (for example, flexible disk, magnetic tape, hard disk drive), a magneto-optical recording medium (for example, magneto-optical disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (Random Access Memory)). Further, the program may be supplied to a computer by a transitory computer readable medium of any type. Examples of a transitory computer readable medium include an electrical signal, an optical signal, and an electromagnetic wave. A transitory computer readable medium can supply the program to a computer via a wired communication channel such as an electric wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art.

The present invention is based upon and claims the benefit of priority from Japanese patent application No. 2018-062093, filed on Mar. 28, 2018, the disclosure of which is incorporated herein in its entirety by reference.

### REFERENCE SIGNS LIST

10 information processing apparatus
11 attribute selection unit
12 model generation unit
13 attribute score calculation unit
15 data storage unit
16 model storage unit
100 information processing apparatus
110 model generation means
120 attribute change means

1. An information processing apparatus comprising:
a memory storing instructions; and
at least one processor configured to execute the instructions, the instructions comprising:
based on data including a plurality of attributes, generating a model using the attributes; and
changing the attributes used for generating the model, based on the generated model; and
further generating a new model, based on data including the changed attributes.

2. The information processing apparatus according to claim 1, wherein
the instructions further comprise:
eliminating at least one attribute of the attributes used in the model, based on the generated model, and
generating a new model, based on data including another attribute that is different from the eliminated attribute.

3. The information processing apparatus according to claim 1, wherein
the instructions further comprise determining an attribute to be eliminated based on used states of the attributes in the generated model, and eliminating the attribute.

4. The information processing apparatus according to claim 3, wherein
the instructions further comprise calculating an effecting degree of each of the attributes according to a criterion preset to the model based on the used states of the attributes in the generated model, and eliminating the attribute having a high effecting degree.

5. The information processing apparatus according to claim 3, wherein
the instructions further comprise:
performing generation of the model a plurality of times based on data including same attributes, and
determining the attribute to be eliminated based on a number of the attributes used in a plurality of generated models.

6. The information processing apparatus according to claim 3, wherein
the instructions further comprise:
generating the model including a decision tree, and
determining the attribute to be eliminated based on a distance from a root node in the decision tree of the attributes used in the generated model.

7. (canceled)

8. (canceled)

9. (canceled)

10. The information processing apparatus according to claim 2, wherein
the instructions further comprise eliminating the at least one attribute that is uncontrollable according to a preset criterion.

11. The information processing apparatus according to claim 1, wherein
the instructions further comprise:
generating a plurality of models using the attributes, and
determining an attribute to be eliminated based on used states of the attributes in the plurality of the generated models, and eliminating the attribute.

12. The information processing apparatus according to claim 11, wherein
the instructions further comprise evaluating each of the plurality of the generated models by a preset method, setting, to each of the models, a weight according to an evaluation result of each of the models, determining the attribute to be eliminated based on the used state of each attribute in each of the models and the weight set to each of the models, and eliminating the attribute.

13. An information processing method comprising:
based on data including a plurality of attributes, generating a model using the attributes;
changing the attributes used for generating the model, based on the generated model; and
further generating a new model, based on data including the changed attributes.

14. The information processing method according to claim 13, further comprising;
based on the generated model, eliminating at least one attribute of the attributes used in the model; and
generating a new model, based on data including another attribute that is different from the eliminated attribute.

15. The information processing method according to claim 13, further comprising
determining an attribute to be eliminated based on used states of the attributes in the generated model, and eliminating the attribute.

16. The information processing method according to claim 15, further comprising
calculating an effecting degree of each of the attributes according to a criterion preset to the model based on the used states of the attributes in the generated model, and eliminating the attribute having a high effecting degree.

17. The information processing method according to claim 15, wherein
the generating the model includes performing generation of the model a plurality of times, based on data including same attributes, and
the method further comprises determining the attribute to be eliminated based on a number of the attributes used in a plurality of generated models.

18. The information processing method according to claim 15, wherein
the generating the model includes generating the model including a decision tree, and
the method further comprises determining the attribute to be eliminated based on a distance from a root node in the decision tree of the attributes used in the generated model.

19. The information processing method according to claim 15, wherein
the generating the model includes generating the model including a decision tree in which a leaf node is a regression formula including the attribute, and
the method further comprises determining the attribute to be eliminated based on a coefficient of the attribute in the regression formula in the generated model.

20. The information processing method according to claim 15, wherein
the generating the model includes generating the model including a decision tree in which a leaf node is a regression formula including the attribute and a node other than the leaf node is a branch condition including the attribute, and
the method further comprises determining the attribute to be eliminated based on a number of units of the data used in generation of the branch condition and/or the regression formula in the decision tree of the generated model.

21. The information processing method according to claim 15, further comprising
eliminating at least one attribute of the plurality of the attributes, based on relevance among the plurality of the attributes used in the generated model.

22. The information processing method according to claim 14, further comprising
eliminating the at least one attribute that is uncontrollable according to a preset criterion.

23. A non-transitory computer-readable medium storing a program comprising instructions for causing an information processing apparatus to execute processing of:
based on data including a plurality of attributes, generating a model using the attributes;
changing the attributes used for generating the model, based on the generated model; and
further generating a new model, based on data including the changed attributes.
